(19) United States
(12) Patent Application Publication
(10) Pub. No.: US 2022/0033560 A1
(43) Pub. Date: Feb. 3, 2022

(54) METHOD FOR PREPARING HEAT-MOISTURE-RESISTANT POLYURETHANE ELASTOMER

(71) Applicant: NATIONAL CHUNG SHAN INSTITUTE OF SCIENCE, TAOYUAN CITY (TW)

(72) Inventors: CHANG-LUN LEE, Taoyuan City (TW); BEI-HUW SHEN, Taoyuan City (TW); CHENG-EN LEE, Taoyuan City (TW); BIING-SHANN YU, Taoyuan City (TW); MING-HUANG LIN, Taoyuan City (TW); CHIN-LUNG CHIANG, Taoyuan City (TW)

(21) Appl. No.: 16/944,190

(22) Filed: Jul. 31, 2020

(51) Int. Cl. C08G 8/12; C08G 18/32; C08G 18/48; C08G 18/75; C08L 75/08

(52) U.S. Cl. CPC C08G 8/12; C08G 18/3206; C08L 2201/08; C08G 18/755; C08L 75/08; C08G 18/48

(57) ABSTRACT

A method for preparing a heat-moisture-resistant polyurethane elastomer includes (A) providing a polyol and an aliphatic diisocyanate to react in the presence of a suitable catalyst under a heating environment, thereby forming a urethane prepolymer with an reactive isocyanate terminal group; (B) providing a hydrophobic diol with a hydroxyl group and/or a castor oil-based triol as a chain extender; and (C) performing an addition reaction of the urethane prepolymer and the chain extender under an appropriate heating environment to generate the heat-moisture-resistant polyurethane elastomer that can be used for a long time in a warm and humid environment.

### BACKGROUND OF THE INVENTION

### 1. Field of the Invention

The present disclosure relates to a method for preparing a polyurethane elastomer, and in particular to a method for preparing a heat-moisture-resistant polyurethane elastomer that can be used for a long time in a warm and humid environment.

### 2. Description of the Related Art

Polyurethane (PU) is made from polyol, isocyanate, chain extender and other raw materials. Polyurethane is formed by polymerization reaction of diisocyanate with polyols or low-molecular-weight polypolyols to form the urethane prepolymer, followed by the chain extension reaction under the addition of the chain extender with amine groups or hydroxyl functional groups to form high-molecular-weight polymers. Polyurethane (PU) contains both soft segments and hard segments, in which the high cross-linking density produces products that tend to be hard, such as rigid foam, and the low cross-linking density produces soft and flexible products like soft foam and soft elastomers. The hard segment as reinforcement provides multi-functional physical cross-linking, and the soft segment has mobility and exhibits soft and flexible properties. Further, with the characteristics similar to a cross-linking point, the hard segment can restrain and fix the soft segments with mobility, so that under the interaction of the soft segments and the hard segments, the polyurethane material has very broad physical properties. When the polymer contains several urethane chemical structures, it can be called polyurethane. The chemical functional group structure of polyurethane is shown as FIG. 1.

Polyurethane polymer materials have been widely used in a variety of people's livelihood and industrial products, including: runway pavement, flooring, shoe materials, sealant coating materials, adhesives, artificial leather, furniture seats, rollers, etc., which occupies a very important position in our daily life. The conventional polyurethane elastomer is made by mixing all raw materials including: polyol, diisocyanate, and the chain extender at the same time, followed by heat hardening reaction, thereby obtaining polyurethane.

Diisocyanates can be divided into two major categories of aromatic and aliphatic diisocyanates. Traditionally, aromatic toluene diisocyanate (TDI) is used as the starting isocyanate for urethane prepolymers. Due to the high volatility, pungent odor, carcinogenicity and high toxicity of toluene diisocyanate, it is urgent to find the suitable alternative materials to reduce human health hazards.

In addition to diisocyanates, another important starting material for preparing urethane prepolymers is polyols. Polyols can be divided into polyester polyols and polyether polyols. The advantages of polyether polyols are hydrolysis resistance, ultraviolet resistance and low temperature resistance. Though polyester polyols have the disadvantage of being prone to hydrolysis, they have the advantages of good wear resistance and oil resistance.

In order to meet the characteristics of polyurethane elastomer materials, urethane prepolymers composed of toluene diisocyanate often need to use the chain extender to induce interactive reaction between the urethane prepolymers having terminal isocyanate for forming polyurethane elastomer material. The industry often uses chloroaniline, i.e. 4,4′-methylenebis-2-chloroaniline (MOCA,), as the chain extender, which heats and crosslinks urethane prepolymer composed of toluene diisocyanate to produce the final polyurethane elastomer material. However, because of the carcinogenicity of chloroaniline, the EU sunset clause for chloroaniline had been launched in November 2017, so manufacturers of elastomer materials urgently need alternative materials. In addition, due to the nature of the polyurethane polymer material, its heat resistance and moisture resistance are still insufficient. If it is used for a long time in a high humidity environment, the polyurethane elastomer material is prone to hydrolysis. Also, as time goes by, the hydrolysis will become more and more serious, causing the material to collapse and disintegrate. Therefore, it is increasingly urgent to improve the performance in a warm and humid environment of polyurethane elastomer materials.

In summary, the current various synthesis methods have their own advantages and disadvantages. The applicant of this application hopes to extract the advantages of the various synthesis methods after painstaking research, and has developed a method for preparing a heat-moisture-resistant polyurethane elastomer. The method has the advantages of heat and moisture resistance and low pollution, and has a great market potential in the application of high-performance watertight materials and related watertight components, such as offshore wind turbines, underwater connectors, marine sonar components, submarine cables, underwater remote control vehicles, etc.

### BRIEF SUMMARY OF THE INVENTION

In view of the shortcomings of the conventional technologies, the object of the present invention is to provide a method for preparing a heat-moisture-resistant polyurethane elastomer, which enhances the moisture resistance of polyurethanes by binding with highly hydrophobic castor oil-based hydrocarbons. Moreover, the branched hydrocarbon molecule configuration reduces the polarity of the diol and thus enhances the compatibility of the chain extender and the aliphatic urethane prepolymer, thereby improving the overall performance of polyurethane elastomer materials. The method has the advantages of heat and moisture resistance and low pollution, and has a great market potential in the application of high-performance watertight materials and related watertight components, such as offshore wind turbines, underwater connectors, marine sonar components, underwater sensing components, submarine cables, underwater remote control vehicles, etc.

To achieve the above object, according to a solution proposed by the present invention, a method for preparing a heat-moisture-resistant polyurethane elastomer is provided. The method for preparing a heat-moisture-resistant polyurethane elastomer comprising: (A) providing a polyol and an aliphatic diisocyanate to react in the presence of a suitable catalyst under a heating environment, thereby forming a urethane prepolymer with an reactive isocyanate terminal group; (B) providing a diol with a hydroxyl group and/or a castor oil-based triol as a chain extender; and (C) performing an addition reaction of the urethane prepolymer and the chain extender under an appropriate heating environment to generate the heat-moisture-resistant polyurethane elastomer.

Preferably, a molecular weight of the urethane prepolymer ranges from 1,500 to 5,000.

Preferably, the aliphatic diisocyanate is isophorone diisocyanate.

Preferably, the polyol is selected from aliphatic polyether polyols with a molecular weight from 750 to 2,300.

Preferably, the diol is selected from diols with a branched hydrocarbon configuration and has a molecular weight of 50 to 500.

Preferably, a weight of the castor oil-based triol is not more than 9% of a total weight of the polyurethane elastomer.

Preferably, the heating environment refers to a temperature range of 80−90° C.

The above summary, the following detailed description and accompanying drawings are intended to further illustrate the ways, means and effects adopted by the present invention to achieve the intended object. The other objects and advantages of the present invention will be explained in the subsequent description and drawings.

### BRIEF DESCRIPTION OF THE DRAWINGS

FIG. 1 shows the structure diagram of conventional polyurethane with chemical functional groups.

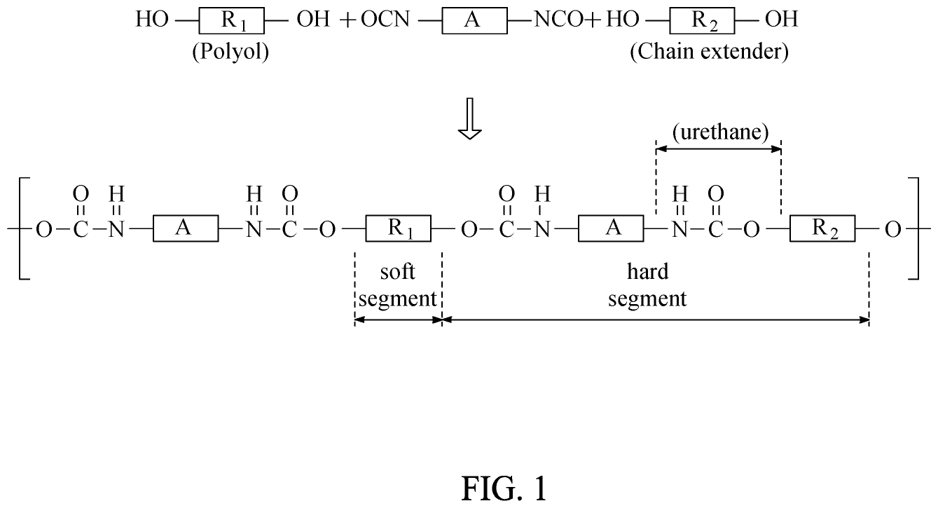

FIG. 2 shows the reaction scheme of the urethane prepolymer.

FIG. 3 shows the reaction scheme of the pure polyurethane material.

FIG. 4 shows the reaction scheme of the polyurethane material containing castor oil.

FIG. 5 shows the spectrum analysis chart of Fourier transform infrared spectrometer (FT-IR) for the urethane prepolymer.

FIG. 6 shows the spectrum analysis chart of Fourier transform infrared spectrometer (FT-IR) for the polyurethane.

FIG. 7 shows the thermogravimetric analysis chart of the polyurethane.

FIG. 8 shows the pyrolysis chart of the polyurethane.

FIG. 9 shows the hardness test chart of the polyurethane.

FIG. 10 shows the flow chart of the method for preparing the heat-moisture-resistant polyurethane elastomer of the present invention.

### DETAILED DESCRIPTION OF THE INVENTION

To facilitate understanding of the object, characteristics and effects of this present disclosure, embodiments together with the attached drawings for the detailed description of the present disclosure are provided.

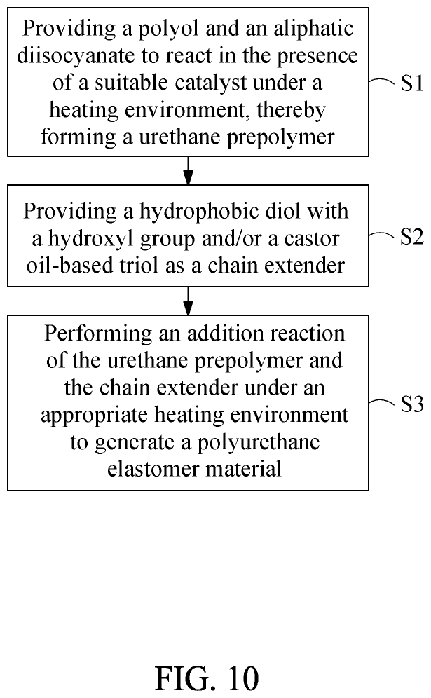

Please refer to FIG. 10. A method for preparing a heat-moisture-resistant polyurethane elastomer of the present invention comprises the following steps. Step S1: providing a polyol and an aliphatic diisocyanate to react in the presence of a suitable catalyst under a heating environment, thereby forming a urethane prepolymer with a reactive isocyanate terminal group. In this embodiment, a polyether polyol having excellent hydrolysis resistance and less likely to crack and oxidize in a high-humidity environment and an aliphatic diisocyanate having excellent ultraviolet resistance and weather resistance are used as the raw materials. Under appropriate reaction conditions, the isocyanate group of excess diisocyanate and the hydroxyl group of the polyol undergo the addition reaction to obtain a liquid aliphatic urethane prepolymer with the reactive isocyanate functional groups. In this embodiment, the aliphatic diisocyanate may be isophorone diisocyanate. The polyol may be selected from aliphatic polyether polyols, and may have a molecular weight from 750 to 2,300. In addition, a molecular weight of the urethane prepolymer may range from 1,500 to 5,000.

Step S2: providing a diol with a hydroxyl group and/or a castor oil-based triol as a chain extender. In this embodiment, the chain extender may include: a branched aliphatic diol, or a highly hydrophobic castor oil-based hydrocarbon. The branched aliphatic diol uses low-polarity hydroxyhydrocarbon having carbon branch without toxic chloroaniline (none-MOCA), 4,4′-methylenebis-dichloroaniline (MOCA), as the chain extender to enhance the compatibility of chain extenders with aliphatic urethane prepolymers. The use of highly hydrophobic castor oil-based hydrocarbons having active hydroxyl group as the chain extender can further enhance the moisture resistance of polyurethanes.

In the present embodiment, the diol may be selected from diols with a branched hydrocarbon configuration and have a molecular weight of 50 to 500. Further, a weight of the castor oil-based triol is not more than 9% of a total weight of the polyurethane elastomer.

In the above, the soft segments composed of the polyol and the hard segments composed of isocyanate and the chain extender are alternately interspersed in polyurethane, which reduces the polarity of the diol by the branched configuration, enhances the compatibility of the chain extender and the aliphatic urethane prepolymer, and also avoids the potential shortcomings resulted from the regular arrangement and stacking crystallization of the linear hydrocarbons, such as flexibility reduction after long-time use or gradual hardening of the elastomer. Therefore, the flexibility of the soft segments can be kept, and the hard segments can be used as cross-link points to connect the soft segments in series, thereby generating the elastomer material with good physical properties.

Step S3: performing an addition reaction of the urethane prepolymer and the chain extender under an appropriate heating environment to generate a polyurethane elastomer material. In this embodiment, through the hardening reaction upon heating, the hydroxyl group of the chain extender and the residual diisocyanate of the urethane prepolymer are fully reacted to form a high-molecular-weight polyurethane elastomer, which has low shrinkage and improved heat-moisture-resistance.

In this embodiment, the heating environment is in a temperature range of 80-90° C. In the invention, under the heating environment of 80-90° C., the urethane prepolymer and the chain extender are uniformly mixed and then poured into the heated mold. The isocyanate at the end of the urethane prepolymer and the active functional group of the chain extender undergo the cross-linking and hardening reaction, thereby being fully reacted to produce the high-molecular-weight polyurethane elastomer. The shrinkage of the finished product is low, which can improve the heat-moisture-resistant property of the material.

In the above, the present invention is different from the traditional one-step process, and the production of polyurethane elastomer adopts the two-step process. First, excess diisocyanate and polyol are used as the starting materials. After the addition polymerization reaction, the urethane prepolymer with a regular molecular arrangement is obtained. Afterwards, the chain extender and the residual diisocyanate of the prepolymer are subjected to the crosslinking hardening reaction to obtain the polyurethane elastomer material with extremely high-molecular-weight and good physical properties. The materials have high batch-to-batch reproducibility and stable quality. The advantages of the two-step process include: low viscosity and easy processing of liquid prepolymer, low heat release from the crosslinking reaction, and low shrinkage of finished products. The issues, such as random arrangement of the molecular structure of the finished product, high reaction heat release, difficult temperature control, diisocyanate monomer exposure hazard to personnel health, high shrinkage of hardening, large variation of physical properties from batch to batch, etc. of the conventional one-step process that mixes all the raw materials including polyol, diisocyanate and the chain extender at the same time for hardening reaction can be solved.

The following descriptions illustrate the method for preparing a heat-moisture-resistant polyurethane elastomer of the present invention by way of example.

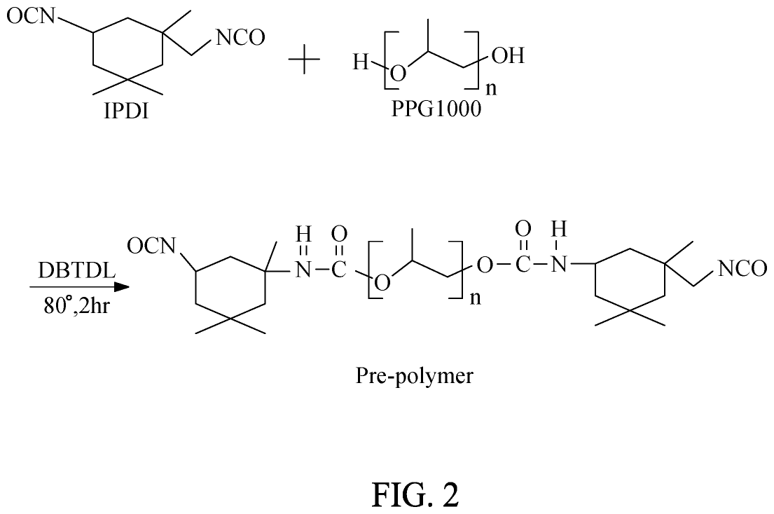

The preparation method of the urethane prepolymer of the present invention first put 10 g of polypropylene glycol (referred to as PPG) (polypropylene glycol 1000) into a four-neck separation reaction tank, in which the temperature was set to 80° C. and a magnetic stirrer was provided for stirring. Next, 9 g of isophorone diisocyanate (IPDI) was slowly dropped into the four-neck separation reaction tank to react with polypropylene glycol (PPG1000), provided that 0.3 g of a metal catalyst (dibutyltin dilaurate, DBTDL) was added, the temperature was set to 80° C., and the reaction time was 2 hours, in order to generate the urethane prepolymer. The reaction scheme is shown in FIG. 2.

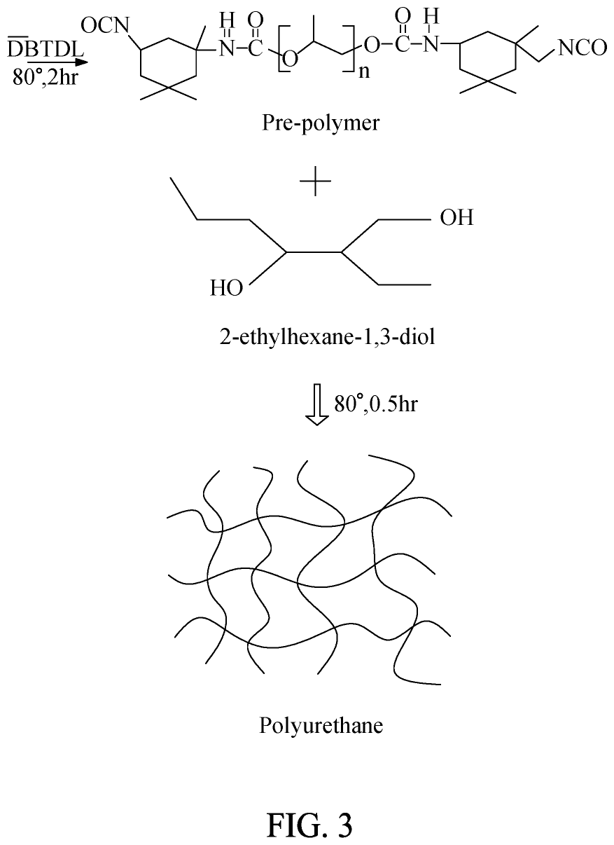

The preparation method of the pure polyurethane CO-PU 0% (without castor oil (CO)) material of the present invention first put 10 g of polypropylene glycol (polypropylene glycol 1000, PPG1000) in a four-neck flask. Next, 9 g of isophorone diisocyanate (IPDI) was slowly introduced into the flask with the addition of 0.3 g metal catalyst (dibutyltin dilaurate, DBTDL). The magnetic stirrer was used for stirring to mix the mixture in the flask uniformly. The reaction was conducted at 80° C. for 2 hours. After that, 2.93 g of the chain extender 2-ethylhexane-1,3-diol was dropped into the mixture slowly, and the reaction was continued with stirring at 80° C. for 0.5 hours. Whether the viscosity was increased and the liquid level was lowered or not was investigated during the experiment. Afterwards, the mixture was poured into a Teflon mold and degassed in a vacuum oven at 80° C. for 1 day, followed by staying in a circulating oven at 80° C. for 1 day. Finally, the finished product was taken out and cooled at room temperature to obtain the pure polyurethane CO-PU 0% material without castor oil CO. The reaction scheme is shown in FIG. 3.

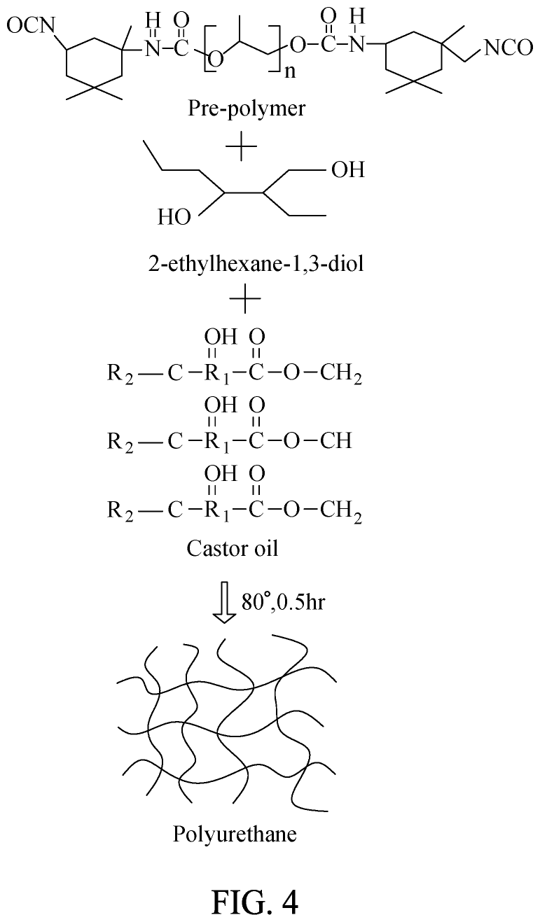

The preparation method of the polyurethane CO-PU 2%, 4% and 6% (weight percent of castor oil-based triol in the total weight of the polyurethane elastomer) material of the present invention first put 10 g of polypropylene glycol (polypropylene glycol 1000, PPG1000) in a four-neck flask. Next, 9 g of isophorone diisocyanate (IPDI) was slowly introduced into the flask with the addition of 0.3 g metal catalyst (dibutyltin dilaurate, DBTDL). The magnetic stirrer was used for stirring to mix the mixture in the flask uniformly. The reaction was conducted at 80° C. for 2 hours. After that, 2.4 g of the chain extender 2-ethylhexane-1,3-diol and a suitable amount (as shown in Table 1) of castor oil (CO) was dropped into the mixture slowly, and the reaction was continued with stirring at 80° C. for 0.5 hours. When the viscosity was increased obviously, the mixture was poured into a Teflon mold and degassed in a vacuum oven at 80° C. for 1 day, followed by staying in a circulating oven at 80° C. for 1 day. Finally, the finished product was taken out and cooled at room temperature to obtain the polyurethane CO-PU 2%, 4% and 6% materials containing castor oil. The reaction scheme is shown in FIG. 4.

TABLE 1
The amount of castor oil CO for CO-PU
0%, 2%, 4% and 6% materials:

| Sample NO. | Castor oil CO (g) | |
|---|---|---|
| CO-PU 0% | 0 | g |
| CO-PU 2% | 0.35 | g |
| CO-PU 4% | 0.71 | g |
| CO-PU 6% | 1.07 | g |

CO: Castor oil

The following provides the explanation for the results obtained by the test procedure of the present invention.

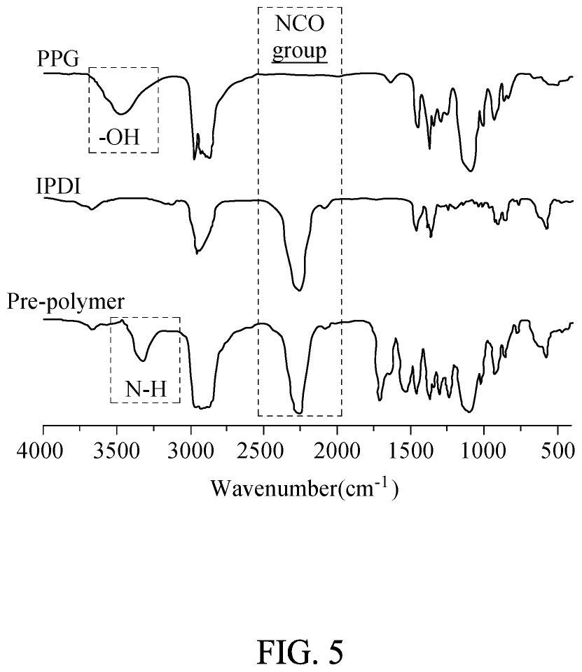

Through the spectrum analysis of Fourier transform infrared spectrometer (FT-IR) for the polyurethane of the present invention, polypropylene glycol 1000 (PPG) reacts with isophorone diisocyanate (IPDI) to obtain urethane prepolymer. It can be seen from FIG. 5 that polypropylene glycol (PPG) has obvious hydroxyl group (—OH) located around 3600-3500 cm⁻¹, and isophorone diisocyanate (IPDI) also has obvious isocyanate (—NCO) peak located at 2270 cm⁻¹. After a period of reaction between —OH and —NCO, it can be found that the urethane prepolymer shows a new peak of amino group (—NH).

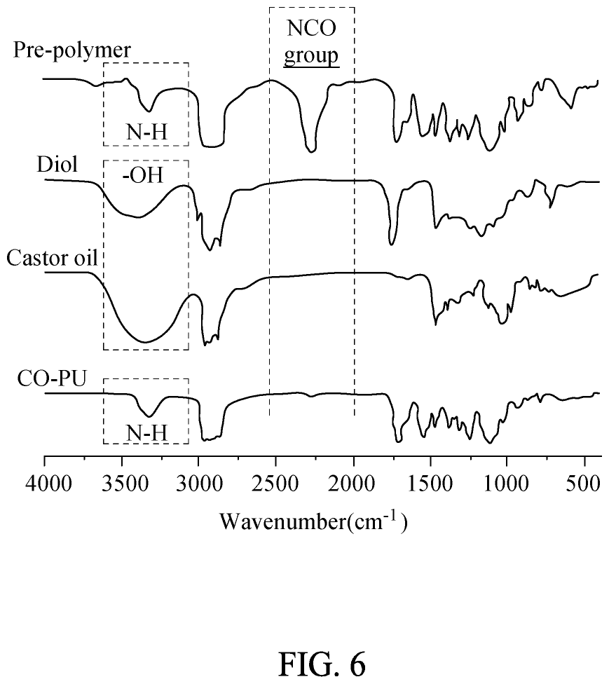

FIG. 6 shows the change of functional groups of the polyurethane (CO-PU) formed from the reaction of the urethane prepolymer with the chain extender diol and castor oil. After the —NCO of the urethane prepolymer reacts with the —OH of the chain extender, the resulting polyurethane (CO-PU) has no peak of —NCO functional group, indicating that the polyurethane (CO-PU) has been prepared.

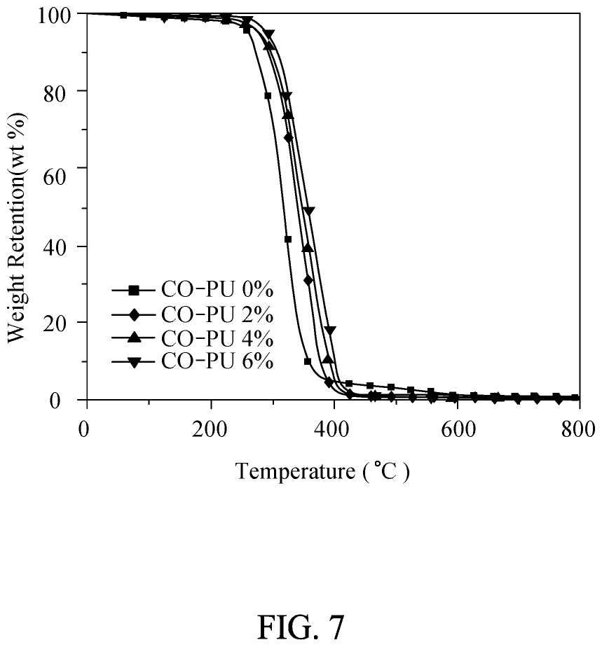

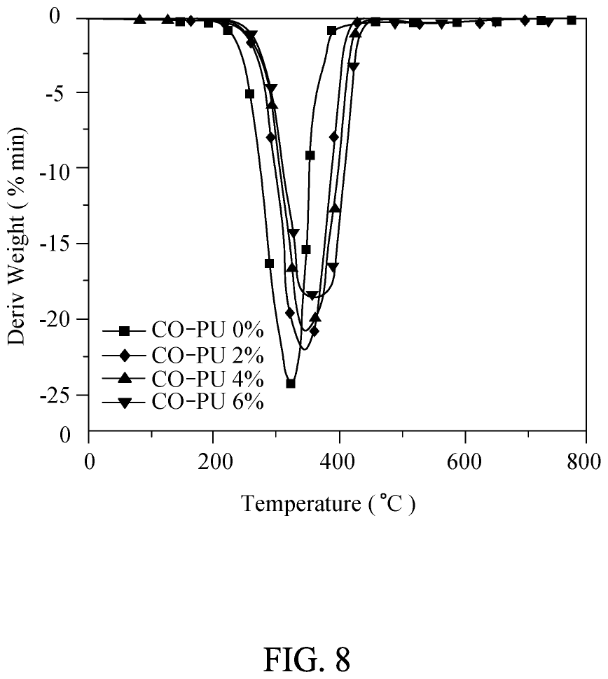

The thermogravimetric analysis (TGA) instrument is used to evaluate the thermal properties of polyurethane with different castor oil (CO) contents. FIGS. 7-8 and Table 2 show that as the castor oil (CO) content increases from 0% to 6%, the initial pyrolysis temperature of 30% weight loss of the material increases from 300° C. to 334.7° C., the maximum pyrolysis temperature (Tmax) also increases from 322° C. to 364° C., and the pyrolysis rate (Rmax) of DTG (derivative thermo-gravimetry) curve is eased from −24 (wt %/min) of pure polyurethane (PU) to −18 (wt %/min) of polyurethane containing castor oil (CO-PU 6%). As to the overall properties it can be clearly observed from the pyrolysis curve that the pyrolysis rate is delayed more as the castor oil (CO) content increases, indicating that the polyurethane containing castor oil (CO-PU) can indeed improve the thermal properties of polyurethane.

TABLE 2
Relationship between the thermal properties of
polyurethane and the content of castor oil (CO)

| | T_{d30} | Tₘₐₓ | Rₘₐₓ |
|---|---|---|---|
| Sample NO. | (° C.) | (° C.) | (wt %/min) |
| PU | 300.0 | 322 | −24 |
| CO-PU 2% | 321.9 | 343 | −22 |
| CO-PU 4% | 328 | 348 | −20 |
| CO-PU 6% | 334.7 | 364 | −18 |

T_{d30}: the initial pyrolysis temperature of 30% weight loss of the material (° C.)
Tₘₐₓ: the maximum pyrolysis temperature (° C.)
Rₘₐₓ: the maximum pyrolysis rate of DTG curve (wt %/min)

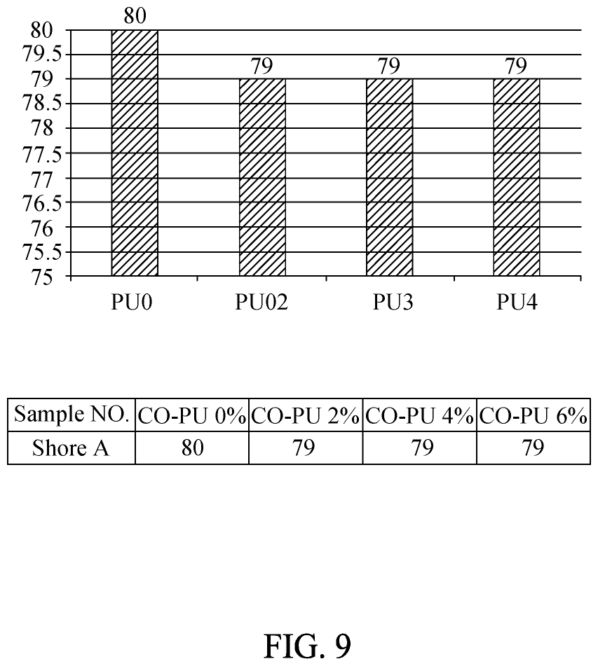

In addition, with respect to the hardness characteristics of polyurethane, the Shore A hardness tester was used to test the hardness of the experimental sample with a thickness of 6 mm according to the ASTM D2240 specification. The needle was really close contact with the sample surface for one second to obtain the maximum value of the hardness of the sample. After that, it was continued to repeat the test 5 times at different positions spaced at least 6 mm from each other according to the previous steps and calculate the average value. As shown in FIG. 9, the measured average hardness of the polyurethane (CO-PU) material is shore A 79.

Furthermore, with regard to the water-absorbing properties of polyurethane, the polyurethane material absorbs moisture in water or in a humid environment to increase its weight, which is called water absorption. According to the ASTM D570 specification, water absorption test was performed on polyurethane. The sample was first dried in an oven at 50° C., then taken out and weighed, placed in a beaker and soaked in deionized water for 24 hours, then taken out to remove excess water and weighed in order to calculate its water absorption using the formula. The data in Table 3 shows that compared to pure polyurethane materials, the polyurethane containing castor oil (CO-PU6%) has a lower water absorption rate.

TABLE 3
Water absorption test of soaking in deionized water for 24 hours

| Sample NO. | 1 | 2 | 3 | Average |
|---|---|---|---|---|
| PU 0% | 2.2 | 1.6 | 1.8 | 1.87% |
| COPU 6% | 0.3 | 1.0 | 0.2 | 0.50% |

The water absorption rate is expressed as the increase percentage of the average weight of three test pieces.

Water absorption rate %=[(weight of absorbed water−weight of dried sample)/weight of dried sample]×100

In summary, the method for preparing the heat-moisture-resistant polyurethane elastomer of the present invention adopts the two-step process. The excess diisocyanate and polyol are used as the starting materials. After the addition polymerization reaction, the urethane prepolymer with a regular molecular arrangement is obtained. Afterwards, the chain extender and the residual diisocyanate of the prepolymer are subjected to the crosslinking and hardening reaction to obtain the polyurethane elastomer material with good physical properties. The materials have high batch-to-batch reproducibility and stable quality. The liquid prepolymer is low in viscosity and thus easy to be processed. The crosslinking reaction produces low heat release, the finished products have low shrinkage, and the heat-moisture resistance of polyurethane elastomer materials is improved. The present invention improves the compatibility between the chain extender and the aliphatic polymer prepolymer by discarding the toxic chloroaniline (MOCA) chain extender and using environmentally friendly low-polarity and branched diol chain extender. The use of highly hydrophobic castor oil-based hydrocarbons having reactive hydroxyl group as the chain extender further enhances the moisture resistance of polyurethanes and improves the overall performance of the elastomer materials. Through the hardening reaction upon heating, the hydroxyl group of the chain extender and the residual diisocyanate of the urethane prepolymer of the present invention are fully reacted to form the high-molecular-weight polyurethane elastomer, which has low shrinkage and improved heat-moisture-resistance. The present invention enhances the moisture resistance of polyurethanes by binding with highly hydrophobic castor oil-based hydrocarbons. Moreover, the branched hydrocarbon molecule configuration reduces the polarity of the diol and thus enhances the compatibility between the chain extender and the aliphatic urethane prepolymer, thereby improving the overall performance of polyurethane elastomer materials. The method has the advantages of heat and moisture resistance and low pollution, and also has a great market potential in the application of high-performance watertight materials and related watertight components, such as offshore wind turbines, underwater connectors, marine sonar components, underwater sensing components, submarine cables, underwater remote control vehicles, etc.

While the present disclosure has been described by means of specific embodiments, numerous modifications and variations could be made thereto by those skilled in the art without departing from the scope and spirit of the present disclosure set forth in the claims.

What is claimed is:

1. A method for preparing a heat-moisture-resistant polyurethane elastomer, comprising:
(A) providing a polyol and an aliphatic diisocyanate to react in the presence of a suitable catalyst under a heating environment, thereby forming a urethane prepolymer with a reactive isocyanate terminal group;
(B) providing a diol with a hydroxyl group and/or a castor oil-based triol as a chain extender; and
(C) performing an addition reaction of the urethane prepolymer and the chain extender under an appropriate heating environment to generate a polyurethane elastomer material.

2. The method for preparing a heat-moisture-resistant polyurethane elastomer of claim 1, wherein a molecular weight of the urethane prepolymer ranges from 1,500 to 5,000.

3. The method for preparing a heat-moisture-resistant polyurethane elastomer of claim 1, wherein the aliphatic diisocyanate is isophorone diisocyanate.

4. The method for preparing a heat-moisture-resistant polyurethane elastomer of claim 1, wherein the polyol is selected from aliphatic polyether polyols with a molecular weight from 750 to 2,300.

5. The method for preparing a heat-moisture-resistant polyurethane elastomer of claim 1, wherein the diol is selected from diols with a branched hydrocarbon configuration and has a molecular weight of 50 to 500.

6. The method for preparing a heat-moisture-resistant polyurethane elastomer of claim 1, wherein a weight of the castor oil-based triol is not more than 9% of a total weight of the polyurethane elastomer.

7. The method for preparing a heat-moisture-resistant polyurethane elastomer of claim 1, wherein the heating environment refers to a temperature range of 80-90° C.
